(19) United States
(12) Patent Application Publication
(10) Pub. No.: US 2009/0145739 A1
(43) Pub. Date: Jun. 11, 2009

(54) Water treatment system

(75) Inventor: Bill G. Cotten, Van Nuys, CA (US)

Correspondence Address: STETINA BRUNDA GARRED & BRUCKER, 75 ENTERPRISE, SUITE 250, ALISO VIEJO, CA, 92656, US

(73) Assignee: Sundar Industries, LLC

(21) Appl. No.: 11/985,454

(22) Filed: Nov. 15, 2007

(51) Int. Cl. C02F 1/04; C02F 103/08

(52) U.S. Cl. 203/11; 202/185.1

(57) ABSTRACT

A desalinization device is provided. The desalinization device may comprise a tank body divided into a condenser chamber and a vaporization chamber. The vaporization chamber is operative to receive salt water and transfer water vapor to the condenser chamber via a turbine. The remaining salt water may be concentrated with solid and removed from the vaporization chamber through a brine outlet. As the water vapor is transferred through the turbine, the water vapor experiences a temperature drop from the inlet to the outlet of the turbine. The temperature drop of the water vapor and water outlet introduced into the condenser chamber at a temperature about equal to the temperature of the water vapor at the turbine condenses the water vapor to fresh water. The fresh water produced by the device may be siphoned and reintroduced into the condenser chamber or used in another condenser chamber of a second desalinization device. Excess fresh water may be removed from the condenser chamber via fresh water outlet and stored in a fresh water reservoir.

### CROSS-REFERENCE TO RELATED APPLICATIONS

The aspects of the device disclosed herein may be related to U.S. Pat. Nos. 1,061,206 and 6,692,232, the entire contents of which are expressly incorporated herein by reference.

### STATEMENT RE: FEDERALLY SPONSORED RESEARCH/DEVELOPMENT

Not Applicable

### BACKGROUND

The present invention relates to a desalinization device, and more generally, to a device for removing salts, minerals, or dissolved solids from water to produce fresh water for a variety of purposes.

Fresh water is an essential element for life on earth. Fresh water is utilized for many purposes including animal consumption, irrigation and human consumption. Unfortunately, certain areas of the world do not have a sufficient supply of fresh water to meet the needs of their community. Accordingly, these communities have resorted to expensive man made methods of producing fresh water from seawater or water sources that are initially unsuitable for fresh water purposes.

The two leading methods for producing fresh water are reverse osmosis and multi-stage flash. Reverse osmosis is a type of membrane process wherein water is forced through a semi permeable membrane. The water is allowed to proceed through the semi permeable membrane but minerals, salts and contaminants are trapped within the semi permeable membrane. Although the membrane process uses less energy than thermal distillation, it is still an energy intensive process which increases the cost to produce fresh water and uses chemicals.

Multi-stage flash distillation generally involves heating sea water then moving the heated sea water through a series of containers at a successively lower pressure. The sudden introduction of the heated water into the lower pressure stage causes the sea water to boil very rapidly such that the water flashes into steam. The flashed steam is condensed on tubes that run through each stage. The condensed water is collected in a fresh water reservoir.

Despite numerous advances in the art, the desalinization process is still expensive and cost prohibitive in many instances. Accordingly, there is a need in the art for an improved desalinization device.

### BRIEF SUMMARY

The desalinization device discussed herein addresses the problems discussed above, discussed below and those that are known in the art.

The desalinization device may comprise a tank body that is operative to withstand a vacuum pressure, specifically, a pressure below ambient pressure or a pressure at or below a vaporization pressure of the water to be purified (e.g., sea water, water with high levels of totally dissolved solids, etc.). The tank body may be separated into two chambers, namely, a vaporization chamber and a condenser chamber. The condenser chamber may be disposed above the vaporization chamber. The vaporization chamber may be in fluid communication with the condenser chamber via a turbine. The turbine produces a temperature drop in water vapor being transferred from the vaporization chamber to the condenser chamber. The vaporization chamber may also have a salt water inlet for introducing salt water into the vaporization chamber. After the salt water is vaporized, the remaining salt water is concentrated with salt/minerals and may now be characterized as brine. The brine may be removed from the vaporization chamber via a brine outlet.

As discussed above, when the water vapor is transferred from the vaporization chamber to the condenser chamber through the turbine, the temperature of the water vapor is reduced. The temperature reduction may aid in condensing the water vapor into fresh water. A certain portion of the water vapor may condense into fresh water due to the temperature drop alone. However, a primary means of condensing the water is the combination of the temperature reduction and water introduced into the condenser chamber via a spray condenser system. The water from the spray condenser system is preferably at the same temperature of the water vapor at the outlet of the turbine. The condensate (i.e., fresh water) may now be removed from the condenser chamber via a fresh water outlet. Since the temperature of the water used to condense the water vapor exiting the turbine is about equal to the temperature of the water vapor exiting the turbine outlet, the condensed water may be reintroduced into the condenser chamber to assist in condensing more water vapors exiting the turbine outlet or may be diverted to a condenser chamber of a second device.

The vacuum pressure in the vaporization chamber may be produced by attaching a vacuum pump to the condenser chamber. Since the condenser chamber and vaporization chamber are in fluid communication with each other, the reduced pressure created in the condenser chamber by the vacuum pump is also operative to reduce the pressure within the vaporization chamber.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a desalinization device;

FIG. 2 is a plane view of the desalinization device shown in FIG. 1;

FIG. 3A is a front cross-sectional view of a disc turbine;

FIG. 3B is a side cross-sectional view of the disc turbine shown in FIG. 3A; and

FIG. 4 is an illustration of a manifold for routing water vapor from a vaporization chamber through the turbine and into a condenser chamber.

### DETAILED DESCRIPTION

Referring now to the drawings, a desalinization device 10 is shown. The desalinization device 10 may be operative to remove salt from sea water 14 to produce fresh water 16 through a distillation process. Although the device 10 discussed herein is discussed in relation to the removal of salt from sea water, the device 10 may also be used to remove minerals and other dissolved solids from water that may make the contaminated water unsuitable for human consumption or other fresh water purposes. For example, the device 10 may be used to remove minerals, salts, contaminants and/or dissolved solids from water. Accordingly, the aspects of the device 10 discussed herein may be applied to removal of dissolved solids in water and should not be limited to salt water context.

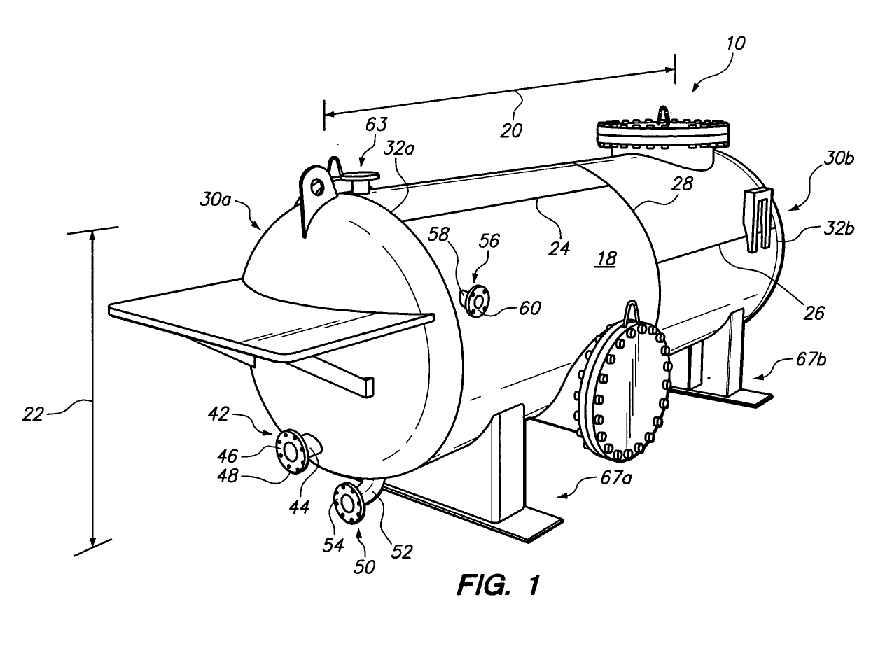

The desalinization device 10 may comprise a vacuum tank body 18. To fabricate the vacuum tank body 18, a first plate may be rolled with its opposed ends welded to each other, as shown by weld line 24 in FIG. 1. A second plate may also be rolled with its opposed distal ends welded together as shown by weld line 26 in FIG. 1. These two cylindrical rolled plates may be welded end to end as shown by weld line 28 in FIG. 1. End caps 30a, b may be attached to the opposed ends of the rolled and welded plates, as shown by weld lines 32a, b in FIG. 1.

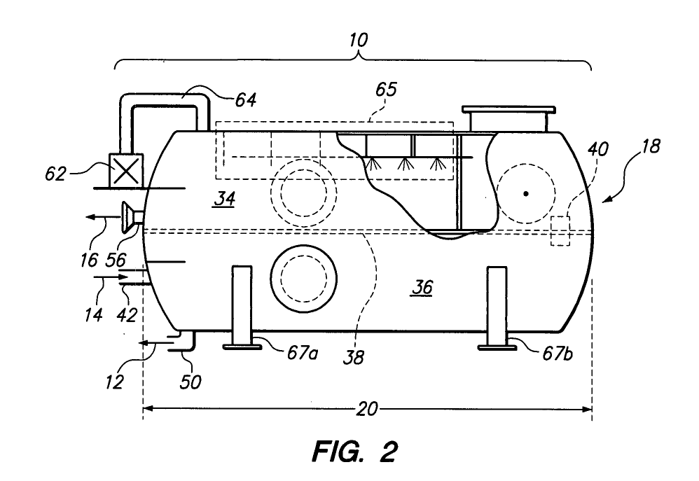

The vacuum tank body 18 may be divided into two chambers, namely, a condenser chamber 34 and a vaporization chamber 36, as shown in FIG. 2. The condenser chamber 34 may be located above the vaporization chamber 36. The chambers 34, 36 may be in fluid communication with each other via a turbine 40. It is contemplated that the condenser chamber 34 may be in fluid communication with the vaporization chamber 36 solely through the turbine 40 or through a plurality of turbines 40. The vacuum tank body 18 may be divided into the two chambers 34, 36 by welding a flat plate 38 within an interior surface of the vacuum tank body 18. The flat plate 38 may be horizontally oriented. The surfaces of the valve tank body 18 and the flat plate 38 may be coated with a rust proof coating.

The vaporization chamber 36 may have a salt water inlet 42 which is operative to transfer salt water (e.g., sea water, etc.) from outside of the vacuum tank body 18 to within the vaporization chamber 36. The salt water inlet 42 may be fabricated by welding a nozzle 44 (see FIG. 1) to an opening within the end cap 30a (see FIG. 1). The nozzle 44 may additionally have a flange 46 (see FIG. 1) with mounting bolt holes 48 for attaching the salt water inlet 42 to a salt water source. The salt water inlet 42 may introduce the salt water 14 into the desalinization device 10.

The vaporization chamber 36 may additionally have a brine outlet 50. The brine outlet 50 may be operative to dispose of brine 12 after the salt water has been desalinized. The brine outlet 50 may comprise a nozzle 52 attached to an opening on an under side of the vacuum tank body 18. A flange 54 with mounting bolts may be attached to the nozzle 52 for mounting the nozzle 52 to a brine reservoir.

The condenser chamber 34 may be connected to a fresh water outlet 56 for transferring desalinized or fresh water from the condenser chamber 34 to a fresh water tank reservoir. The fresh water outlet 56 may comprise a nozzle 58 and a flange 60 with mounting bolts for attaching the fresh water outlet 56 to the fresh water reservoir.

The condenser chamber 34 may additionally be attached to a vacuum pump 62 (see FIG. 2) via a pipe 64. The pipe 64 may be attached to a nozzle 63 (see FIG. 1). The vacuum pump 62 may be operative to produce a vacuum pressure within the vaporization chamber 36 below ambient atmospheric pressure or a pressure at or below the vaporization pressure of the incoming salt water 14. Since the vaporization chamber 36 and the condenser chamber 34 are in fluid communication, the vacuum pressure may induce a pressure within the vaporization chamber 36 to below ambient atmospheric pressure or a pressure at or below the vaporization pressure of the incoming salt water 14.

The condenser chamber 34 may additionally have a spray condenser system 65 (see FIG. 2) which may be operative to introduce water into the condenser chamber 34 to further assist in condensing water vapor into fresh water 16. The water sprayed from the spray condenser system 65 may be in the form of water droplets or a mist. The temperature of the water droplets or mist may be about equal to a temperature of the water vapor at the outlet 68 of the turbine 40. Alternatively, it is contemplated that the temperature of the water droplets or mist may be lower than a temperature of the water vapor at the outlet 68 of the turbine 40.

The valve tank body 18 may also be supported by legs 67a, b. These legs 67a, b may be welded to an underside of the valve tank body 18 and prevent the valve tank body 18 from rolling.

The turbine 40 which fluidly connects the vaporization chamber 36 and the condenser chamber 34 may be an impeller turbine, tesla turbine, disc turbine, turbines known in the art and those that are developed in the future. Turbines that may be used in the device 10 is a tesla turbine which is describe in U.S. Pat. No. 1,061,206 or a disc turbine which is described in U.S. Pat. No. 6,692,232. The disclosures of U.S. Pat. Nos. 1,061,206 and 6,692,232 are expressly incorporated herein by reference. The turbine 40 may be any one of the above-mentioned turbines or variations thereof.

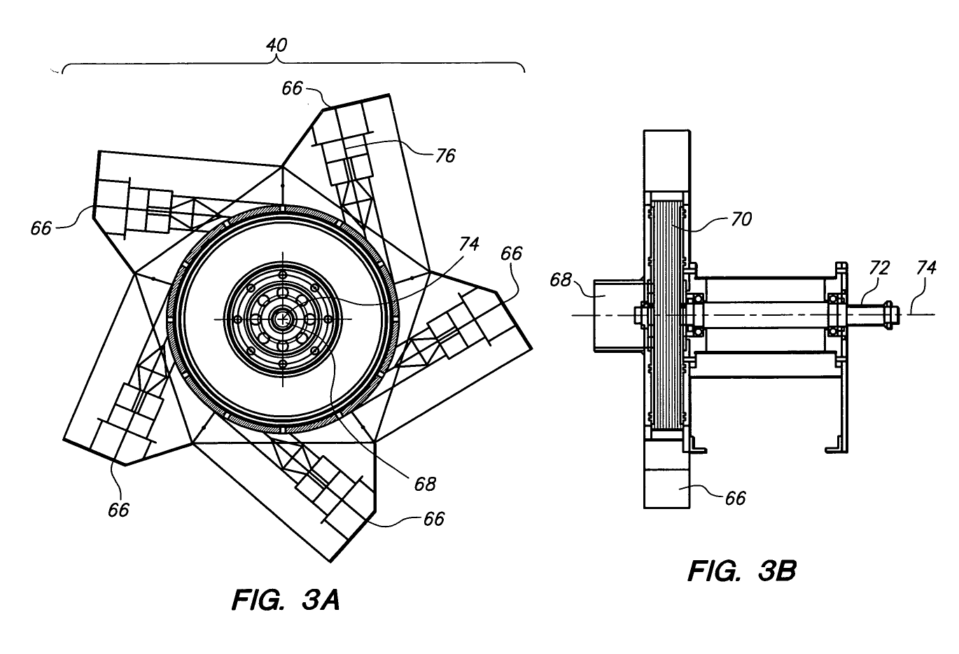

Referring now to FIGS. 3A and 3B, a modified tesla turbine is shown. The turbine shown in FIG. 3A has five inlets 66. It is contemplated that the turbine 40 may have one or more inlets 66 as desired. The number of inlets 66 may be limited by the size of the turbine. Water vapor from the vaporization chamber 36 may proceed into the inlets 66 and exit out of an outlet 68. The turbine 40 may have a plurality of smooth discs 70 (see FIG. 3B) concentrically aligned to each other and closely packed with each other. These smooth discs 70 may be mounted onto a spindle 72 and rotatable about a spindle axis 74. The inlets 66 may define a longitudinal axis 76. The longitudinal axes 76 of the inlets 66 may be aligned generally tangential to an outer circumference of the smooth disc 70. The inlets 66 may all be oriented in the same direction to turn the discs 70 in the same direction when water vapor flows through the inlets 66. Accordingly, when water vapor flows into the inlets 66, the water vapor will tend to penetrate between the smooth discs 70. Due to the viscosity of the water vapor and the adhesion of the water vapor, the flow of water vapor between the smooth discs 70 causes the discs 70 to rotate and the spindle 72 to rotate. As the discs 70 rotate, the water vapor will tend to approach the center of the smooth discs 70, near the spindle axis 74. The water vapor will then exit out of the outlet 68 into the condenser chamber 34 at a temperature lower than a temperature at the inlet 66. The temperature drop from the inlet 66 to the outlet 68 may be approximately 25° F. to approximately 50° F., and more particularly, approximately 30° F. to approximately 40° F.

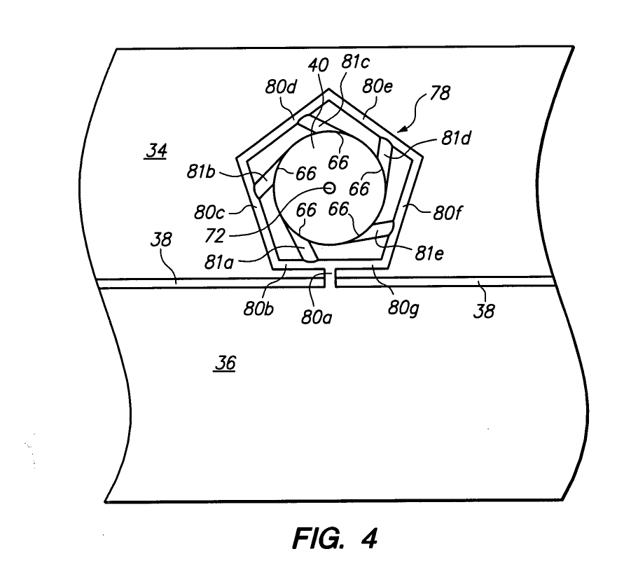

The vaporization chamber 36 may be connected to a manifold 78 (see FIG. 4). The manifold 78 delivers the water vapor from the vaporization chamber 36 to the inlets 66 of the turbine 40. More particularly, the divider 38 may have an aperture. The aperture may be connected to a plurality of pipes 80a-g. Pipe 80a may extend upwardly from the aperture of the divider 38. From the pipe 80a, pipes 80b and 80g may extend oppositely away from each other. Pipes b-g may form a pentagram sized and configured to be disposed about a circumference of the turbine 40. Each of the pipes 80b, c, d, e and f may be routed to each of the inlets 66 of the turbine 40 via manifold exits 81a-e. The turbine 40 may be mounted on the divider 38 such that the spindle 72 is parallel with the divider 39 and generally horizontal with the ground.

The pipe 80a may have a cross-sectional area of about 1.25 times an aggregate total of the cross-sectional area of the manifold exits 81a-e. Under Charles law for behavior of gases, T1V2=T2V1 wherein temperature (T) is in degrees Fahrenheit and volume (V) is cross-sectional area in square inches. Velocity of the water vapor through the turbine 40 is created via the reduction in cross-sectional area from pipe 80a to the pipes 80b-80f to the manifold exits 81a-e. This is similar to a Venturi tube in aircraft instrumentation to create a high velocity gas. As the water vapor enters the manifold 78, the water vapor is accelerated at a higher rate by gradually or incrementally reducing the cross section of the pipes 80a-g and manifold exits 81a-e. The water vapor may further be accelerated through the turbine inlets 66 (i.e., injection ports) by forming the inlets 66 to have slightly smaller cross-sectional area than the manifold exits 81a-e. After the water vapor passes through the five inlets 66 of the turbine 40, the volumetric area inside the turbine 40 may be greater than the total cross-sectional area of the five manifold exits 81a-e. This allows an expansion of the water vapor. Since there is a rapid change of cross-section, the water vapor experiences a temperature drop. The water vapor also tangentially impacts the plurality of discs. The water vapor flowing through the turbine 40 has potential energy. The formula for potential energy is F=M×V² wherein F (force) is in foot pounds of torque, M (mass) is the density of the water vapor in one cubic foot, and V (velocity) is the speed of the water vapor squared. The turbine 40 absorbs the expanded high velocity water vapor and the interaction causes the discs of the turbine 40 and its shaft 68 to rotate. This translates the water vapor's potential energy into kinetic energy. The kinetic energy is converted into shaft rotation. The kinetic energy of the expanded water vapor rapidly diminishes. Since there are at least two principles, namely, expansion and impacted energy absorption occurring simultaneously, there may be a temperature drop of the water vapor across the turbine 40. The temperature drop in the water vapor across the turbine 40 and as will be discussed below, the water introduced into the condenser chamber 34 assist in the condensation of the water vapor into liquid.

In use, the condenser chamber 34 may be initially primed by lowering the temperature of the condenser chamber 34. For example, the spray condenser system 65 may inject a mist of cold water into the condenser chamber 34. Other methods of lowering the temperature of the condenser chamber 34 are also contemplated such as refrigeration. At about the same time, salt water 14 may enter the salt water inlet 42. The salt water may have a temperature less than 212 degrees Fahrenheit. The vacuum pump 62 may reduce the pressure within the condenser chamber 34 as well as the vaporization chamber 36. The vacuum pump 62 may reduce the pressure within the vaporization chamber 36 until the salt water boils or until the salt water begins to vaporize. The water vapor contains less salt than the salt water 14 and is transferred to the condenser chamber 34 via the turbine 40. The remaining salt water is concentrated with salt and may now be characterized as brine 12. The brine 12 may exit the vaporization chamber 36 through the brine outlet 50. The water vapor that enters the turbine 40 may experience a temperature drop. The cold mist of water introduced into the condenser chamber 34 may further drop the temperature of the water vapor exiting the turbine 40. Additionally, the vacuum pump 62 may reduce the pressure within the condenser chamber 34. Water vapor in the condenser chamber 34 may be condensed due to (1) the water from the spray condenser system 65 and (2) the reduction in temperature of the water vapor through the turbine. The condensed water or fresh water may then be extracted out of the condenser chamber 34 through the fresh water outlet 56 and transferred into a fresh water reservoir.

The temperature of the water condensate out of the fresh water outlet 56 may be about equal to a temperature of the water vapor exiting the outlet 68 of the turbine 40. Accordingly, the condensed water extracted from the fresh water outlet 56 of one desalinization device 10 may be injected into a condenser chamber 34 of a second desalinization device 10 to promote condensation of water vapor in the condenser chamber 34 of the second device 10 or reintroduced into the current desalinization device 10.

It is contemplated that devices peripheral to the vacuum pump 62 may receive additional power. For example, the spray condenser system 65 may provide a mist of cold water to the condenser chamber 34. In this regard, power may be supplied to the spray condenser system 65 to reduce the temperature of the water sprayed into the condenser chamber 34 to a temperature of the water vapor temperature at the outlet of the turbine and to pump the sprayed water into the condenser chamber 34. Additionally, the salt water 14 may be pumped into the vaporization chamber 36 with a first pump, brine 12 may be pumped out of the vaporization chamber 36 with a second pump and the fresh water 16 may be pumped out of the condenser chamber 34 with a third pump. In this regard, power may be supplied to the first, second and third pumps to transfer the fluid.

It is contemplated that the device 10 may be initially primed by providing a source of water at a temperature about equal to or less than the temperature of the water vapor exiting the turbine. This water may be injected into the condenser chamber 34 via a spray condenser system 65. By way of example and not limitation, the initial source of water may be brought to the temperature of the water vapor at the turbine outlet using ice or a refrigeration system. When the desalinization device 10 is initially started, the vacuum pump 62 may create a vacuum pressure within the vaporization chamber 36 and the condenser chamber 34 to begin the distillation process. The water in the vaporization chamber 36 begins to vaporize and transfer to the condenser chamber 34 through the turbine 40. The turbine 40 removes energy from the water vapors flowing therethrough thereby reducing the temperature of the water vapor. As such, there is a temperature drop in the water vapor as measured at the inlets 66 and outlet 68 of the turbine 40. The spray condenser system 65 introduces water into the condenser chamber 34. The water temperature is at about the same temperature of the water vapor at the turbine outlet 68. This initial source of water provided by the spray condenser system 65 may initially be chilled with ice or a refrigeration unit. However, as the device begins to condensate water vapor into water, the temperature of the condensed water is about the same temperature of the water vapor at the turbine outlet. Accordingly, a portion of the condensed water in the condenser chamber 34 may be reintroduced into the condenser chamber 34 via the spray condenser system 65 or introduced into another condenser chamber 34 of a second device 10. It may be required that the reused condensed water may need to be slightly chilled due to heat loss in the pipe. However, the energy required to slightly chill the reused condensed water may be less than the energy required to chill the water initially introduced into the condenser chamber 34 via the spray condenser system 65.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A distillation device for reducing a concentration of dissolved solids in water, the device comprising:
a vaporization chamber having an inlet, a water outlet and a vapor outlet, the inlet being sized and configured to transfer water from outside the vaporization chamber to inside the vaporization chamber, the vapor outlet being sized and configured to transfer water vapor out of the vaporization chamber, the water outlet being sized and configured to transfer water out of the vaporization chamber;
a vacuum pump in fluid communication with the vaporization chamber to reduce a pressure in the vaporization chamber below ambient atmospheric pressure;
a turbine having an inlet and outlet, the inlet being in fluid communication with the vapor outlet of the vaporization chamber;
a condenser chamber having a fresh water outlet, the condenser chamber being in fluid communication with the outlet of the turbine and the vacuum pump;
wherein a temperature of the water vapor decreases through the turbine as the water vapor is transferred from the water chamber to the condenser chamber to thereby condense the water vapor to fresh water in the condenser chamber.

2. The device of claim 1 wherein the temperature drop across the turbine is about 30 degrees Fahrenheit to about 40 degrees Fahrenheit.

3. The device of claim 1 wherein the vacuum pump reduces the pressure in the water chamber closer to a vaporization pressure of the water than ambient atmospheric pressure.

4. The device of claim 1 wherein the vacuum pump reduces the pressure in the water chamber to or below a vaporization pressure of the water.

5. The device of claim 1 wherein the turbine is a disc turbine.

6. The device of claim 1 wherein the turbine comprises a plurality of inlets, and the device further comprises a manifold connected to the vapor outlet and the turbine inlets to distribute water vapor from the water chamber to the inlets of the turbine.

7. The device of claim 5 wherein the turbine is a disc turbine and the manifold comprises a plurality of outlet tubes which are tangentially aligned in identical direction to discs of the disc turbine for rotating the discs when the water vapor is flowed through the turbine inlets.

8. The device of claim 1 further comprising a spray condenser system connected to the condenser chamber and operative to spray water at a temperature about equal to a water vapor temperature at the turbine outlet into the condenser chamber to promote condensation of the water vapor.

9. The device of claim 1 wherein the dissolved solids is salt.

10. A method for reducing a dissolved solid concentration in water, the method comprising the steps of:
introducing water containing dissolved solids into a vaporization chamber;
reducing a pressure within the vaporization chamber to below ambient atmospheric pressure;
producing water vapor in the vaporization chamber by the reduction of pressure within the vaporization chamber;
transferring the water vapor from the vaporization chamber to a condenser chamber via a turbine;
reducing a temperature of the water vapor as the water vapor flows through the turbine and into the condenser chamber thereby condensing the water vapor into water in the condenser chamber; and
removing the condensed water from condenser chamber.

11. The method of claim 10 wherein the reducing the temperature of the water vapor includes the step of reducing the temperature of the water vapor by about 30 degrees Fahrenheit to about 40 degrees Fahrenheit.

12. The method of claim 10 wherein the reducing the pressure in the vaporization chamber step includes the steps of removing gas out of the vaporization chamber with a vacuum pump.

13. The method of claim 10 further comprising the steps of introducing cold water into the condenser chamber to reduce a temperature of water vapor exiting an outlet of the turbine.

14. The method of claim 10 further comprising the step of:
introducing water into the condenser chamber at a temperature about equal to a water vapor temperature at an outlet of the turbine to assist in condensing the water vapor into water in the condenser chamber.
